(19) United States
(12) Patent Application Publication
(10) Pub. No.: US 2006/0160646 A1
(43) Pub. Date: Jul. 20, 2006

(54) Snap fit belt guard for power trowels

(76) Inventor: Timothy S. Jaszkowiak, Boise, ID (US)

Correspondence Address: Peter M. Midgley;HOLLAND & MIDGLEY, LLP, PO Box 1840, Boise, ID, 83701-1840, US

(21) Appl. No.: 11/331,532

(22) Filed: Jan. 13, 2006

Related U.S. Application Data
(60) Provisional application No. 60/644,920, filed on Jan. 18, 2005.

(51) Int. Cl. B62J 13/00

(52) U.S. Cl. 474/144

(57) ABSTRACT

A snap fit belt guard for a power trowel is disclosed, wherein the means for securement includes a series of slots and corresponding tabs. In some embodiments, the belt guard is manufactured, preferably of a pliable material, with the tabs farther apart than the slots, and the belt guard is squeezed to enable the tabs to fit into the slots. When the pressure is released, the belt guard is locked into place.

### RELATED APPLICATION

This application claims priority to U.S. Provisional Patent Application No. 60/644,920, filed Jan. 18, 2005 and entitled SNAP FIT BELT GUARD FOR POWER TROWELS, the disclosure of which is incorporated herein by reference in its entirety.

### BACKGROUND

Concrete power trowels are used for finishing concrete surfaces as the concrete is curing and hardening. A typical power trowel has a rigid frame which houses at least one blade assembly, and an engine. The engine is usually a gasoline or diesel engine, and is used to provide the motive power for the blade assembly. Other potential “engines” include, but are not limited to, electric motors and hydraulic motors. For “riding” models, an operator's seat and the necessary control systems and levers for operation of the trowel are positioned atop of the engine and the frame assembly. These machines are manufactured in a variety of sizes and weights, with the largest of these machines having not just two, but rather three, rotor and troweling blade assemblies.

Power trowels have belts that drive the blades. The belts often become frayed or even tear. In order to facilitate replacing the belts, power trowels generally have removable belt guards. The belt guard is typically a shell of metal, plastic, or other rigid material that envelops the belt/pulley drive to protect people near the drive from injuries. The belt guard must be removed in order to evaluate the condition of the drive system and maintain the components including the belt.

In order to be removable, belt guards require fasteners, the fasteners usually being nuts and bolts. Removing a belt guard attached with nuts and bolts requires a wrench. Removing the nuts and bolts with a wrench is time consuming, requires that the operator carry a wrench, and creates the possibility that the wrench, nuts, or bolts may become lost. Often, the belt guards are removed once and never replaced, which creates the risk of injury due to the exposure of the belt and other moving components.

### SUMMARY

The above-mentioned drawbacks associated with existing belt guards for power trowels are addressed by embodiments of the present invention, which will be understood by reading and studying the following specification.

In one embodiment, a belt guard comprises a body having a hollow area configured to enclose components of a drive system of a power trowel and at least one tab extending from the body. The at least one tab is configured to frictionally engage with at least one slot on the power trowel. In addition, the belt guard is made of a pliable material.

In another embodiment, a power trowel comprises a frame housing at least one blade assembly, an engine, and a drive system comprising a plurality of components, the drive system being configured to enable the engine to power the at least one blade assembly. The power trowel further comprises a belt guard enclosing at least one component of the drive system. The belt guard comprises a pliable material, and is connected to the power trowel by frictional engagement of slots and tabs.

In another embodiment, a system for retrofitting a removable belt guard onto a power trowel comprises a mounting plate comprising a plurality of slots and a belt guard comprising a plurality of tabs. The belt guard comprises a pliable material and further comprises a hollow area configured to enclose components of a drive system of the power trowel. The tabs are configured to frictionally engage the slots when the belt guard is in a compressed state.

These and other embodiments of the present application will be discussed more fully in the detailed description. The features, functions, and advantages can be achieved independently in various embodiments of the present application, or may be combined in yet other embodiments.

### BRIEF DESCRIPTION OF THE DRAWINGS

FIGS. 1A and 1B illustrate a mounting plate configured to cooperate with a belt guard, in accordance with one embodiment of the present application.

FIGS. 2A and 2B illustrate a belt guard configured to be mounted on a power trowel, in accordance with one embodiment of the present application.

FIGS. 3A and 3B are schematic drawings illustrating how the belt guard shown in FIG. 2 can be engaged with the mounting plate shown in FIG. 1, in accordance with one embodiment of the present application.

FIGS. 4A and 4B illustrate the belt guard of FIG. 2 engaged with the mounting plate of FIG. 1, in accordance with one embodiment of the present application.

FIG. 5 illustrates a power trowel including a mounting plate and a belt guard, in accordance with one embodiment of the present application.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

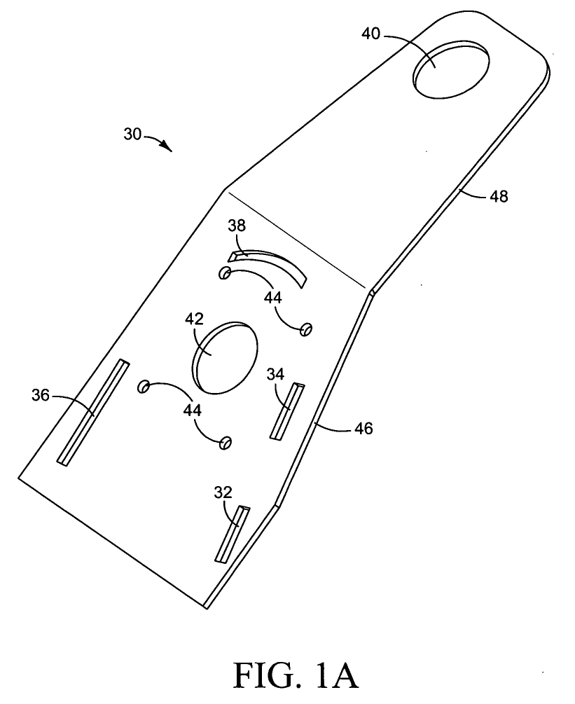

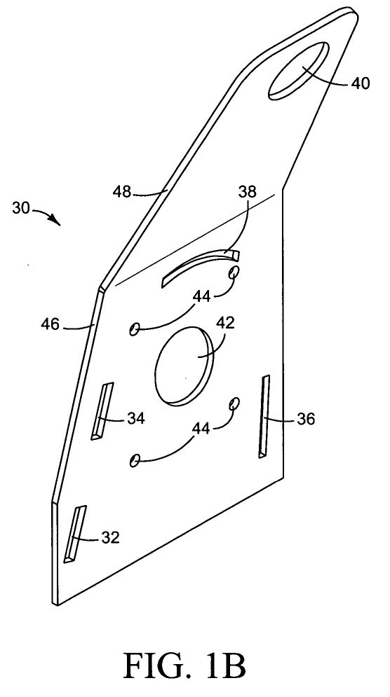

The present application relates to a system and method for enclosing a belt and other components of a drive system for a power tool, such as a power trowel. In some embodiments, the system comprises two pieces. The first piece is illustrated in FIGS. 1A and 1B, and is called a mounting plate 30. The mounting plate 30 attaches directly to the power trowel 50, and may be retrofitted onto existing power trowels 50. The mounting plate 30 is preferably made of metal, but may be made of any other durable, rigid material.

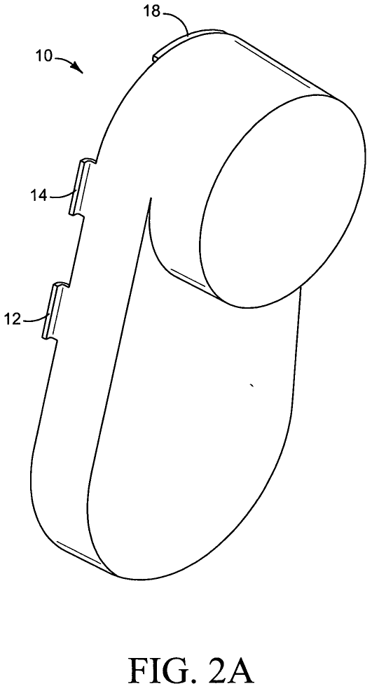

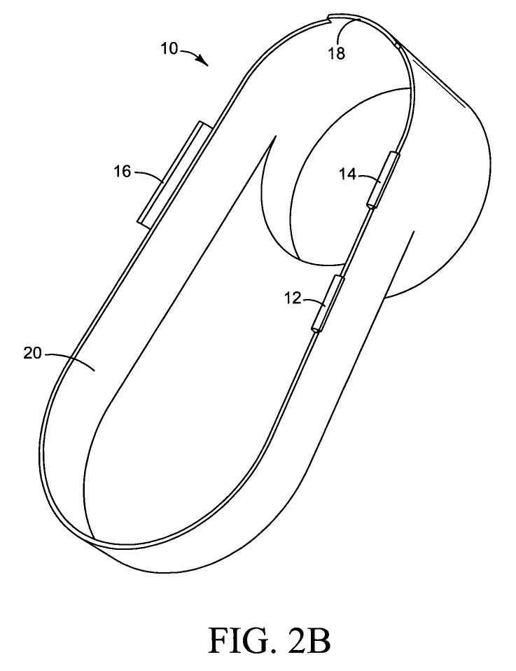

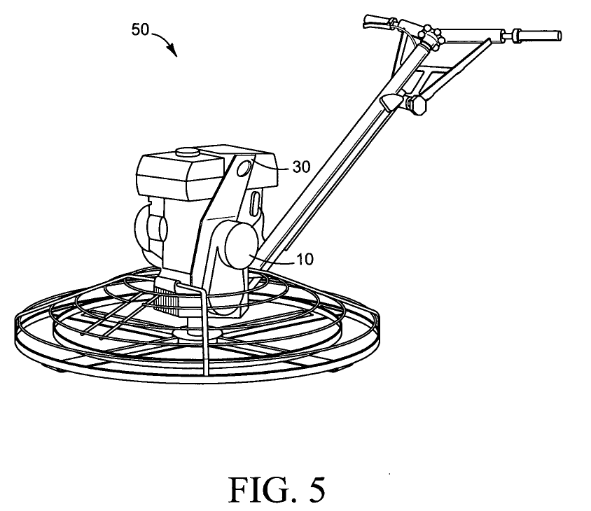

In some embodiments, the mounting plate 30 has four small holes 44 which allow it to be bolted onto a power trowel 50. The mounting plate 30 can also include a first larger hole 40 on its narrow end which allows the mounting plate 30 to function as a lift bale, and can be configured to receive a hook so that a crane can lift the power trowel 50, as shown in FIG. 5. The mounting plate 30 preferably also has a second larger hole 42 surrounded by the four small holes 44. In some embodiments, the mounting plate 30 also has three straight slots 32, 34, 36, which are configured to receive straight tabs 12, 14, 16, from the second piece, called the belt guard 10, which is illustrated in FIGS. 2A and 2B. In addition, in some embodiments, such as the exemplary embodiment illustrated in FIGS. 1A and 1B, the mounting plate 30 also comprises a curved slot 38, which is configured to receive a curved tab 18 from the belt guard 10. The straight slots 32, 34, 36, are preferably located near the perimeter of the mounting plate 30.

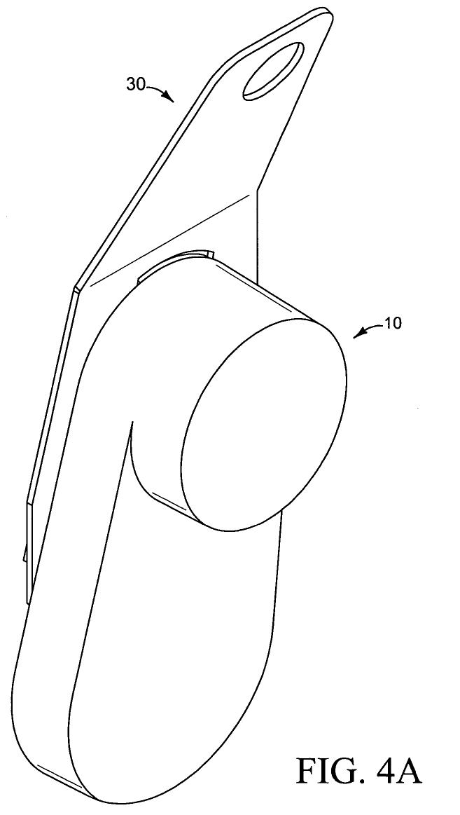

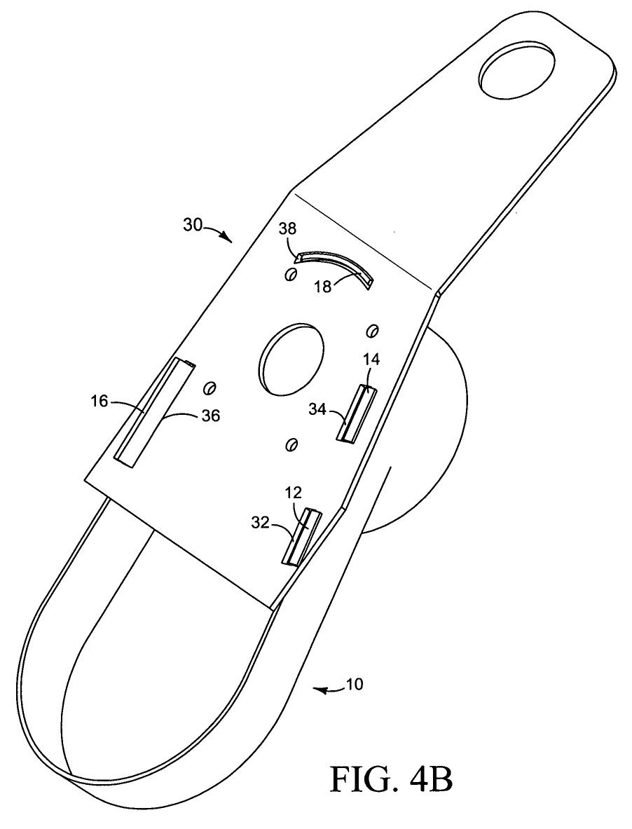

Referring to FIGS. 2A and 2B, the belt guard 10 is preferably made of plastic, but may be made of metal or any other material which is pliable enough for human hands to bend the belt guard 10, yet rigid enough to spring back into position. The belt guard 10 has a hollow area 20 configured to enclose the belt and other components of the drive system, as illustrated in FIGS. 4 and 5.

In some embodiments, the belt guard 10 comprises four tabs 12, 14, 16, 18, that fit into the four slots 32, 34, 36, 38 on the mounting plate 30. The curved tab 18 extends directly away from the belt guard 10. The three straight tabs 12, 14, 16, are preferably located on the bottom of the belt guard 10 that faces toward the mounting plate 30. The three straight tabs 12, 14, 16, preferably extend directly away from the belt guard 10, but then bend in a direction slightly greater than ninety degrees, so that they are extending away from the center of the belt guard 10, as shown in FIGS. 2A and 2B.

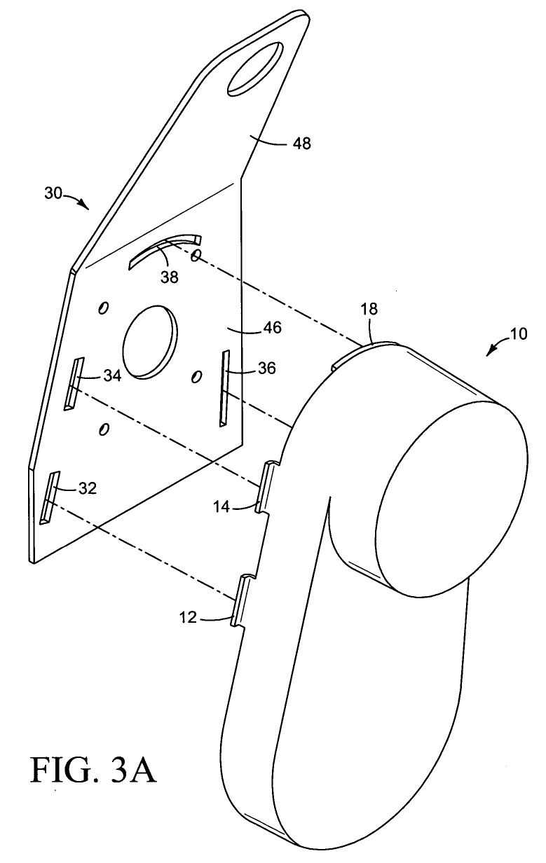

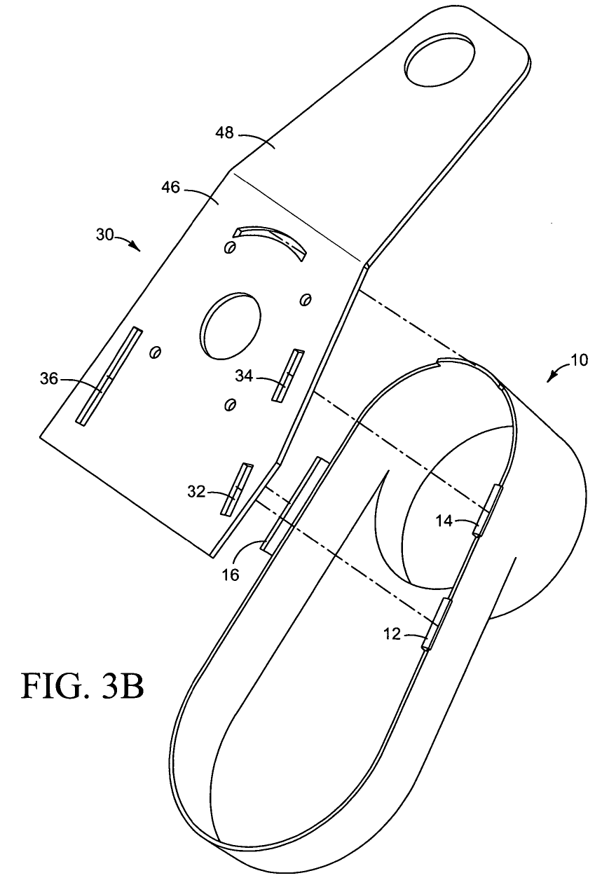

By manually squeezing the belt guard 10, the tabs 12, 14, 16, become close enough together for the tabs 12, 14, 16, all to fit into the slots 32, 34, 36, on the mounting plate 30, as illustrated in FIGS. 3A and 3B. When the pressure is released, the belt guard 10 springs back into its normal shape. Thus installed, the belt guard 10 remains in slight compression so that the tabs 12, 14, 16, are constantly urged outwardly to frictionally engage the outside edges of the slots 32, 34, 36, as shown in FIGS. 4A and 4B. The bend to the straight tabs 12, 14, 16, improves the compression fit. The belt guard 10 can also be removed by manually squeezing the belt guard 10 so that the tabs 12, 14, 16, disengage the slots 32, 34, 36.

The distance between the straight tabs 12, 14, 16, on either side of the belt guard is preferably greater than the distance between the straight slots 32, 34, 36, on the mounting plate 30. The difference between the distances is preferably great enough to cause the tabs 12, 14, 16, to frictionally engage the slots 32, 34, 36, when the belt guard 10 is released and allowed to spring back into its normal shape, yet small enough for a person to be able to manually squeeze the tabs 12, 14, 16, together so that they will fit into the slots 32, 34, 36. In some embodiments, this difference is approximately one-eighth of an inch.

In some embodiments, the system described herein may be retrofitted onto existing power trowels 50 by attaching the mounting plate 30 to the power trowel 50 with nuts and bolts utilizing the four small holes 44. However, it is envisioned that the present invention could be carried out without the mounting plate 30. Instead, another part of the power trowel 50, such as the engine or gear box, could be originally fitted with slots that were configured to receive the tabs 12, 14, 16, 18, of the belt guard 10. Also, the tabs 12, 14, 16, on one side of the belt guard 10 could be replaced with a hinge. Then, instead of the belt guard 10 being removed from the power trowel 50, the belt guard 10 would swing away and allow viewing and access to the drive system. Also, the slots 32, 34, 36, 38, and tabs 12, 14, 16, 18, could be exchanged, i.e., the mounting plate 30 could have tabs, and the belt guard 10 slots. This invention could also be applied to other apparatuses with a cover that needs to be removed and replaced.

The systems and methods described herein present a number of distinct advantages over conventional belt guards. For example, by implementing the systems and methods described herein, workers'time can be saved because it is quicker to remove and replace the belt guard 10 by the present method. It is not necessary to remove the mounting plate 30 to access the belt or other components of the drive system. In addition, no wrenches are required to be carried by the worker, and the possibility of losing fasteners such as nuts and bolts is advantageously eliminated.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A belt guard comprising:
a body having a hollow area configured to enclose components of a drive system of a power trowel; and
at least one tab extending from the body;
wherein the at least one tab is configured to frictionally engage with at least one slot on the power trowel; and
wherein the belt guard is made of a pliable material.

2. The belt guard of claim 1 wherein:
the at least one tab comprises at least two tabs extending from opposite sides of the body; and
the at least two tabs are configured to frictionally engage with at least two slots on the power trowel.

3. The belt guard of claim 2 wherein the at least two tabs bend so that they extend away from a center of the belt guard.

4. The belt guard of claim 1 wherein the pliable material comprises plastic.

5. The belt guard of claim 1 further comprising:
a hinge;
wherein the hinge is connected to a side of the body opposite from the at least one tab.

6. The belt guard of claim 1 wherein:
the at least one tab is a straight tab; and
the belt guard further comprises a curved tab extending from the body.

7. A power trowel comprising:
a frame housing at least one blade assembly;
an engine;
a drive system comprising a plurality of components, the drive system being configured to enable the engine to power the at least one blade assembly; and
a belt guard enclosing at least one component of the drive system;
wherein the belt guard comprises a pliable material; and
wherein the belt guard is connected to the power trowel by frictional engagement of slots and tabs.

8. The power trowel of claim 7 wherein the belt guard comprises no nuts or bolts.

9. The power trowel of claim 7 wherein:
a part of the power trowel comprises slots, said part of the power trowel being selected from the group consisting of the engine, the frame, a gear box, and a mounting plate;
the belt guard comprises tabs; and
the slots are frictionally engaged with the tabs.

10. The power trowel of claim 9 wherein the belt guard, when frictionally engaged with the power trowel, is in a compressed state.

11. The power trowel of claim 10 wherein a distance between the tabs, when the belt guard is in an uncompressed state, is greater than a distance between the slots.

12. The belt guard of claim 7 wherein the pliable material comprises plastic.

13. The power trowel of claim 7 further comprising:
a mounting plate bolted to the frame;
wherein the mounting plate comprises slots;
the belt guard comprises tabs; and
the slots on the mounting plate are frictionally engaged with the tabs on the belt guard.

14. The power trowel of claim 7 wherein:
a part of the power trowel comprises tabs, said part of the power trowel being selected from the group consisting of the engine, the frame, a gear box, and a mounting plate; and
the belt guard comprises slots; and
the tabs are frictionally engaged with the slots.

15. The power trowel of claim 7 wherein:
the belt guard comprises a first side and a second side;
the first side of the belt guard is connected to the power trowel by a hinge; and
the second side of the belt guard is connected to the power trowel by frictional engagement of slots and tabs.

16. A system for retrofitting a removable belt guard onto a power trowel, the system comprising:
a mounting plate comprising a plurality of slots; and
a belt guard comprising a plurality of tabs;
wherein the belt guard further comprises a hollow area configured to enclose components of a drive system of the power trowel;
wherein the belt guard comprises a pliable material; and
wherein the tabs are configured to frictionally engage the slots when the belt guard is in a compressed state.

17. The system of claim 16 wherein a distance between the tabs, when the belt guard is in an uncompressed state, is greater than a distance between the slots.

18. The system of claim 16 wherein:
the mounting plate comprises metal; and
the mounting plate further comprises a plurality of holes;
wherein the plurality of holes are configured to enable the mounting plate to be bolted onto the power trowel.

19. The system of claim 18 wherein the mounting plate further comprises a narrow end with a hole configured to receive a hook.

20. The system of claim 16 wherein:
the belt guard is locked onto the mounting plate; and
the tabs are frictionally engaged with the slots.
